(19) United States
(12) Patent Application Publication
(10) Pub. No.: US 2012/0223564 A1
(43) Pub. Date: Sep. 6, 2012

(54) Armrest Mounting Assembly and Misalignment Indicator

(75) Inventors: Christer Andersson, Trollhattan (SE); Odd Jaegtnes, Nygard (SE)

(73) Assignee: LEAR CORPORATION, Southfield, MI (US)

(21) Appl. No.: 13/508,614

(22) PCT Filed: Dec. 30, 2009
(86) PCT No.: PCT/US09/69814

§ 371 Date: May 8, 2012

(51) Int. Cl. A47C 7/54; B60N 2/46

(52) U.S. Cl. 297/411.3

(57) ABSTRACT

A mounting assembly for an armrest includes a pivot shaft that is fixed relative to one of an armrest and a seat and a brake shaft fixed relative to the pivot shaft. The mounting assembly also includes a resilient restraining member mounted relative to the other of an armrest and a seat. The resilient restraining member is movable between a restrain position in which the resilient restraining member restrains the pivot shaft in an installed position, and a release position in which the resilient restraining member does not restrain the pivot shaft in the installed position. The mounting assembly also includes a brake channel that engages the brake shaft when the pivot shaft is in the installed position. When the pivot shaft is in the installed position the armrest may be pivoted relative to the seat between a use position and a stowed position.

### BACKGROUND OF THE INVENTION

This invention relates in general to an armrest for a seat. Armrests are often included on or adjacent to seats for the comfort of the seat occupant. The armrests provide a place for the occupant to rest his or her forearms. Armrests also often include additional features, such as storage compartments and cup holders.

Vehicles, such as passenger cars, generally have bucket-type seats or bench-type seats. A bucket-type seat may have an armrest on either side, while a bench-type seat may have an armrest in the middle. The middle armrest can be used by an occupant on either side of the bench. The middle armrest is often designed to be pivoted from a use position to a stowed position. In the use position, the armrest presents an armrest surface in a position that is convenient for the occupants to use. In the stowed position, the armrest is rotated up so that the armrest is hidden in the backrest of the bench seat. This allows a third occupant to sit in the seat in the position otherwise occupied by the middle armrest.

The pivoting motion of the middle armrest can be allowed by attaching the armrest to the seat using an assembly that allows an occupant to move the armrest from the stowed position to the use position, but that prevents unwanted movement of the armrest. It would be advantageous to have a mounting assembly that allows the armrest to be more easily installed in the vehicle.

### SUMMARY OF THE INVENTION

This invention relates to a mounting assembly for an armrest. The mounting assembly includes a pivot shaft that is fixed relative to one of an armrest and a seat and a brake shaft fixed relative to the pivot shaft. The mounting assembly also includes a resilient restraining member mounted relative to the other of an armrest and a seat. The resilient restraining member is movable between a restrain position in which the resilient restraining member restrains the pivot shaft in an installed position, and a release position in which the resilient restraining member does not restrain the pivot shaft in the installed position. The mounting assembly also includes a brake channel that engages the brake shaft when the pivot shaft is in the installed position. When the pivot shaft is in the installed position the armrest may be pivoted relative to the seat between a use position and a stowed position.

This invention further relates to a mounting assembly for an armrest that includes a key fixed relative to one of an armrest and a seat and a catch mounted relative to the other of an armrest and a seat. The catch includes a resilient restraining member movable between a restrain position in which the resilient restraining member restrains the key in an installed position, and a release position in which the resilient restraining member does not restrain the key in the installed position. The armrest may be pivoted relative to the seat between a use position and a stowed position when the key is in the installed position. The mounting assembly also includes a misalignment indicator mounted relative to one of the armrest and the seat. The misalignment indicator provides a visually perceptible indication when the armrest is not properly installed relative to the seat.

This invention further relates to a mounting assembly for movably supporting an armrest relative to a seat. The mounting assembly includes a brake sleeve adapted to be supported on one of an armrest or a seat. The brake sleeve included an edge and has a brake channel proved thereon. A restraining member is supported on the brake sleeve, and the restraining member includes an edge. The mounting assembly also includes a pivot shaft that is adapted to be supported on the other of the armrest or the seat. The pivot shaft engages the edge of the brake sleeve and the edge of the retraining member so as to movably support the armrest relative to the seat. The mounting assembly also includes a brake shaft that is adapted to be supported on the other of the armrest or the seat, and engages the brake channel during movement of the armrest relative to the seat.

Various aspects of this invention will become apparent to those skilled in the art from the following detailed description of the disclosed embodiments, when read in light of the accompanying drawings.

### BRIEF DESCRIPTION OF THE DRAWINGS

FIG. 1 is a perspective view of a bench seat including an armrest.

FIG. 2 is an enlarged perspective view of a portion of the bench seat and armrest of FIG. 1, with the bench seat partially cut away in order to illustrate a mounting assembly for the armrest.

FIG. 3 is an exploded, perspective view of a catch of the mounting assembly of FIG. 2.

FIG. 4 is a perspective view similar to FIG. 2, showing the armrest partially installed on the bench seat.

FIG. 5 is a cross sectional view of the mounting assembly taken along the line 5-5 of FIG. 4.

FIG. 6 is a cross sectional view of the mounting assembly similar to FIG. 5, when the armrest has been further installed on the bench seat.

FIG. 7 is a cross sectional view of the mounting assembly similar to FIG. 6, when the armrest has been fully installed on the bench seat.

FIG. 8 is a perspective view of the bench seat and armrest in the use position, showing the armrest properly installed relative to the bench seat.

FIG. 9 is a perspective view similar to FIG. 8, but showing the armrest improperly installed.

FIG. 10 is a perspective view of the bench seat and armrest in the stowed position, showing the armrest properly installed relative to the bench seat.

FIG. 11 is a perspective view similar to FIG. 10, but showing the armrest improperly installed.

### DETAILED DESCRIPTION OF THE PREFERRED EMBODIMENTS

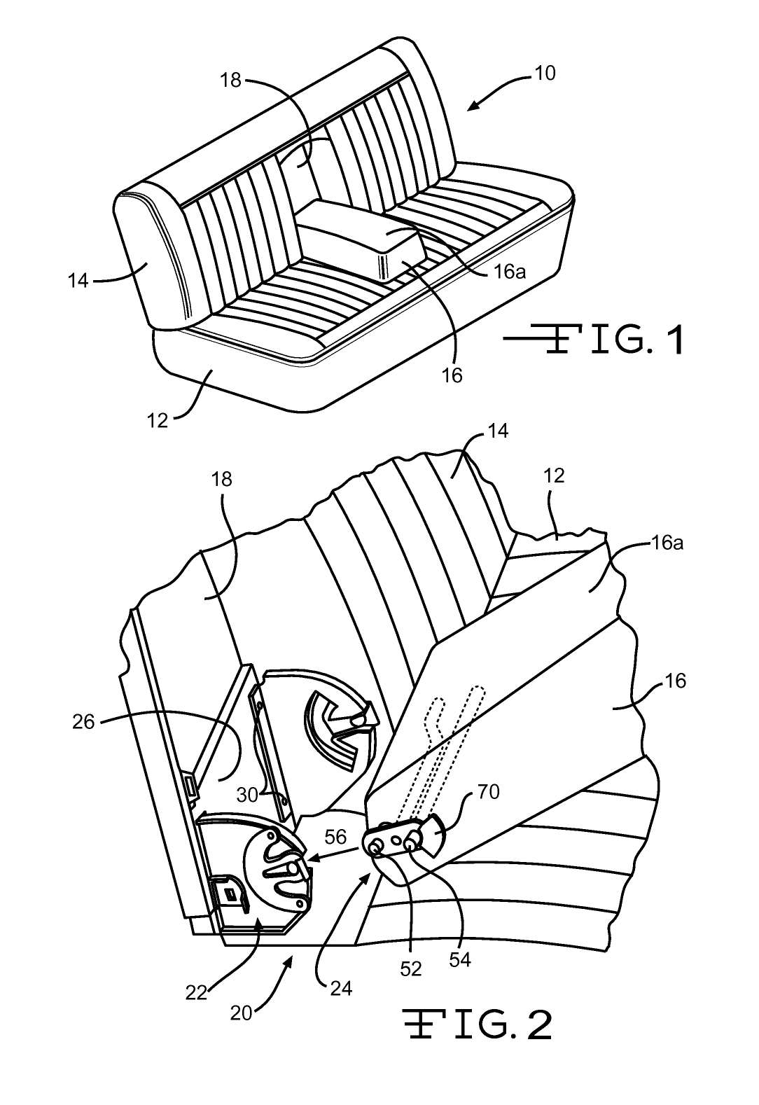

Referring now to the drawings, there is illustrated in FIG. 1 a bench seat 10. The illustrated bench seat 10 is a type commonly installed in the back seat of passenger vehicles. The bench seat 10 includes a seat portion 12 and a back rest 14. The seat portion 12 and the back rest 14 are typically cushioned and upholstered for aesthetics and the comfort of seat occupants. The seat portion 12 and the back rest 14 may be upholstered with leather, fabric, or other desired materials.

An armrest 16 is located substantially in the middle of the bench seat 10. The armrest 16 is able to be pivoted between a use position and a stowed position. The armrest 16 is shown in the use position in FIG. 1. In the use position, the armrest 16 presents a use surface 16a for convenient use by occupants of the bench seat 10. A stowage space 18 is provided in the backrest 14 and is sized to accommodate the armrest 16. The armrest 16 may be pivoted into the stowage space 18. The armrest 16 will generally be cushioned and upholstered for aesthetics and the comfort of the occupants. The armrest 16 may be upholstered with materials to complement the appearance of the bench seat 10. The armrest 16 may also include features such as storage compartments and cup holders if desired. It should be appreciated that the bench seat 10 is used for illustrative purposes only as a seat suitable for the armrest described in herein. The bench seat 10 is not intended to be limiting on where the armrest may be used.

Referring now to FIG. 2, there is shown a mounting assembly, indicated generally at 20, for attaching the armrest 16 relative to the bench seat 10. The mounting assembly 20 includes a catch, indicated generally at 22, and a key, indicated generally at 24. The catch 22 is mounted relative to the backrest 14 and is designed to remain fixed relative to the bench seat 10. The key 24 is mounted relative to the armrest 16. It should be appreciated that the catch 22 may be mounted relative to the seat portion 12 or some other component rather than directly mounting on the bench seat 10. Further, it should be appreciated that the catch 22 may be mounted relative to the armrest 16 and the key 24 may be mounted relative to the bench seat 10.

The catch 22 is mounted on a backrest frame 26. The catch 22 is mounted within the stowage space 18, near the seat portion 12. The catch 22 includes substantially similar elements on either side of the stowage space 18, these components being mirror images of each other along the center line of the stowage space 18.

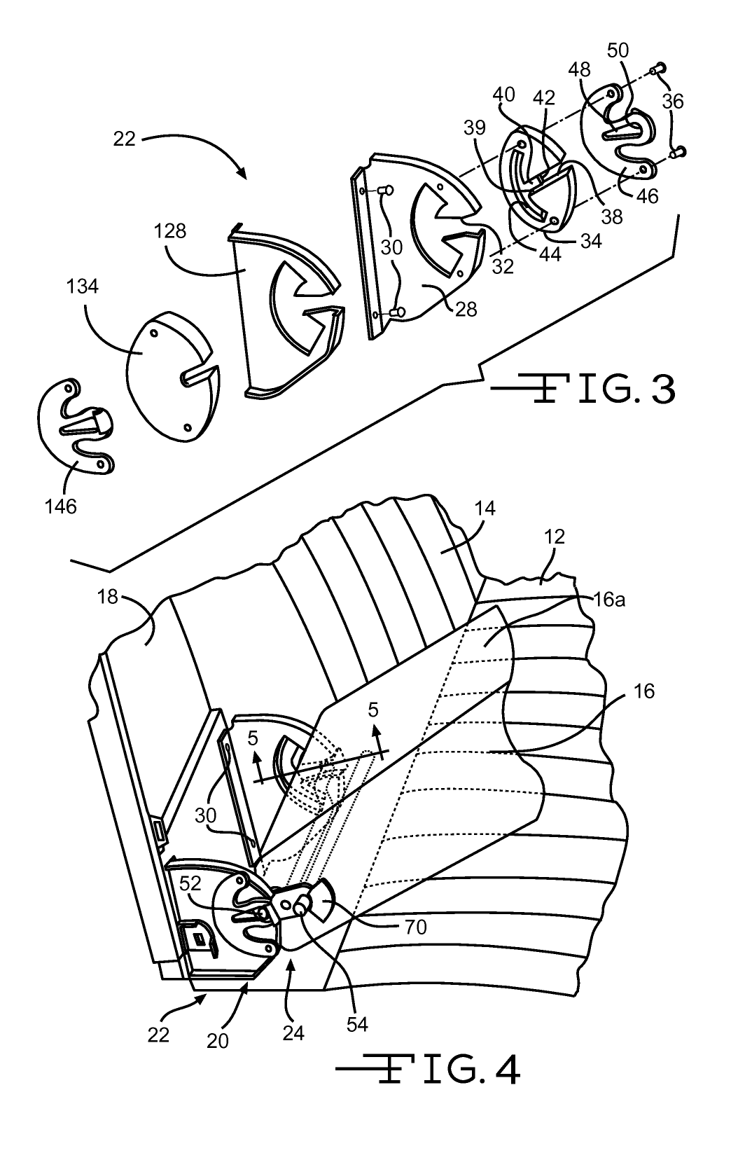

Referring to FIG. 3, an exploded view of the catch 22 is shown. The catch 22 includes a mounting bracket 28. The mounting bracket 28 is made of sheet steel, but may be made of any other desired materials. The mounting bracket 28 is attached to the backrest frame 26 by mounting rivets 30. It should be appreciated that the mounting bracket 28 may be attached to the backrest frame 26 by threaded connectors, welding, adhesives, or other desired connectors. Alternatively, the mounting bracket 28 may be an integral part of the backrest frame 26. The mounting bracket 28 includes a mounting channel 32. The mounting channel 32 is open to accommodate the installation and operation of the key 24, as will be described in detail below.

The catch 22 also includes a brake sleeve 34. The brake sleeve 34 is made of plastic, but may be made of any other desired materials. The brake sleeve 34 has a generally oval shape and is mounted to the mounting bracket 28 by bracket rivets 36. It should be appreciated that the brake sleeve 34 may be attached to the mounting bracket 28 by threaded connectors, welding, adhesives, or other desired connectors. The brake sleeve 34 includes a guide channel 38. The guide channel 38 is an open portion of the brake sleeve 34 that aligns with the mounting channel 32 when the brake sleeve 34 is mounted on the mounting bracket 28. The guide channel 38 includes two guide walls 39 (only one guide wall is visible in the perspective view of FIG. 3) and a guide channel bottom 40. The guide channel bottom 40 ends at a guide edge 42. The brake sleeve 34 also includes a brake channel 44. The brake channel 44 has an arcuate shape. The guide channel 38 is in communication with a brake channel 44. The brake sleeve 34 is designed to accommodate the installation and operation of the key 24, as will be described in detail below.

The catch 22 also includes a hook spring 46. The hook spring 46 is made of spring steel, but may be made of other desired materials. The hook spring 46 is mounted to the brake sleeve 34 by the bracket rivets 36. It should be appreciated that the hook spring 46 may be attached to the brake sleeve 34 by threaded connectors, welding, adhesives, or other desired connectors. The hook spring 46 defines a spring space 48. The hook spring 46 includes a spring edge 50 adjacent to the spring space 48. The hook spring 46 is designed to accommodate the installation and operation of the key 24, as will be described in detail below.

As shown in FIG. 3, the catch 22 also includes a second brake sleeve 134 and a second hook spring 146 that are mounted to a second mounting bracket 128. The second mounting bracket 128, the second brake sleeve 134, and the second hook spring 146 are substantially identical to the mounting bracket 28, the brake sleeve 34, and the hook spring 46, and will not be described separately.

Referring back to FIG. 2, the key 24 includes a brake shaft 52 and a pivot shaft 54. The brake shaft 52 and the pivot shaft 54 are made of steel, but may be made of other desired materials, such as aluminum or plastic. As shown, the brake shaft 52 and the pivot shaft 54 extend completely through the armrest 16. A portion of the brake shaft 52 and a portion of the pivot shaft 54 project from the armrest 16 on each side in order to engage the two brake sleeves 34 and 134 as will be described below. It should be appreciated that the brake shaft 52 and the pivot shaft 54 do not have to extend completely through the armrest 16, and there could be separate shaft sections located on opposites sides of the armrest 16.

In further reference to FIG. 2, the assembled catch 22 is shown. The brake sleeve 34 is attached to the mounting bracket 28 so that the guide channel 38 is aligned with the mounting channel 32.

Referring now to FIG. 4, the armrest 16 is shown with the key 24 partially inserted into the catch 22. The brake shaft 52 is inserted into the guide channel 38 of the brake sleeve 34. It should be appreciated that when one end of the brake shaft 52 is being inserted into the guide channel on brake sleeve 34, the opposite end of the brake shaft 52 on the other side of the armrest 16 may be inserted into the guide channel on the second brake sleeve 134.

Referring now to FIGS. 5 through 7, the operation of the mounting assembly 20 will be described. FIGS. 5 through 7 are cross sectional views, with the views being taken along the line 5-5 of FIG. 4 through the catch 22 and the key 24. The cross sections in FIGS. 5 through 7 are taken through the brake shaft 52 and the pivot shaft 54. As shown in FIG. 5, the brake shaft 52 is sized to be inserted and moved into the guide channel 38 in the direction indicated by arrow 56.

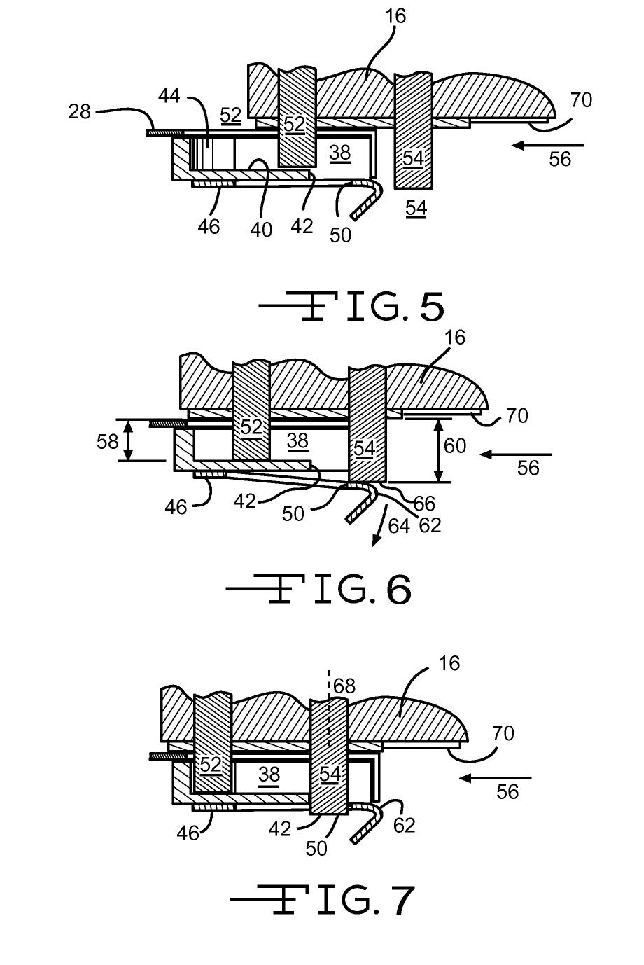

Referring to FIG. 6, as the armrest is moved further in the direction 56, the pivot shaft 54 encounters the hook spring 46. The brake shaft 52 extends a brake shaft length 58 from the side of the armrest 16. The pivot shaft 54 extends a pivot shaft length 60 from the armrest 16. The pivot shaft length 60 is greater than the brake shaft length 58. Therefore, the pivot shaft 54 encounters the hook spring 46, while the brake shaft 58 does not. A leading edge of the hook spring 46 includes a spring release surface 62. The spring release surface 62 is shaped so that when the pivot shaft 54 is moved in the direction 56, it applies a release force on the hook spring 46 in a release direction indicated by the arrow 64. The release force causes the hook spring 46 to be displaced to a release position. When the hook spring 46 is moved to the release position, the pivot shaft 54 is able to be moved further into the guide channel 38 in the direction 56. It should be appreciated that the release surface 62 is not required on the hook spring 46, and the hook spring 46 could be moved to the release position by a force applied by an installer. The installer could be a person or a robot or other machine.

The hook spring 46 is made of a resilient material, and the spring release surface 62 is urged in the direction opposite the release direction 64. Therefore, as the pivot shaft 54 moves farther into the guide channel 38 in the direction 56, the spring release surface 62 engages an outer end 66 of the pivot shaft 54. It should be appreciated that at this point, the key 24 is not restrained within the catch 22 and the pivot shaft 54 may be pulled out of the guide channel 38 in the direction opposite direction 56.

Referring to FIG. 7, the pivot shaft 54 can continue to be moved into the guide channel 38 in the direction 56 until the pivot shaft 54 encounters the guide edge 42. The guide edge 42 prevents further movement of the pivot shaft 54 into the guide channel 38. Further, when the pivot shaft 54 encounters the guide edge 42, the pivot shaft 54 is located within the spring space 48 of the hook spring 46. Once the pivot shaft 54 is in this position, the spring release surface 62 is no longer engaged with the outer end 66 of the pivot shaft 54. Therefore, the resilient hook spring 46 urges the spring release surface 62 into a restrain position, as shown in FIG. 7. As shown in FIG. 7, the pivot shaft 54 is in an installed position. When the pivot shaft 54 is in the installed position, the pivot shaft 54 is restrained from movement into the guide channel 38 (in the direction 56) by the guide edge 42, and the pivot shaft 54 is restrained from movement out of the guide channel 38 (in the direction opposite direction 56) by the spring edge 50. Further, the spring release surface 62 is shaped so that when the pivot shaft 54 is in the installed position, it is unable to provide a force urge the hook spring 46 in the release direction 64. When the pivot shaft 54 is in the installed position, it is restrained from being removed from the brake sleeve 34 by the hook spring 46 and the mounting bracket 28.

As further shown in FIG. 7, when the pivot shaft is 54 is in the installed position, the brake shaft 52 is located in the brake channel 44. The brake channel 44 has an arcuate shape, and the center of the arc substantially coincides with the center of the pivot shaft 54 in its installed position. An axis of rotation 68 of the armrest 16 substantially coincides with the axis of the pivot shaft 54. Therefore, the installed armrest 16 may be pivoted about the pivot shaft 54. During such pivoting movement, the brake shaft 52 will travel within the brake channel 44. The brake channel 44 is sized to frictionally engage the brake shaft 52 in order to prevent unwanted movement of the armrest 16.

It should be appreciated that the previously described mounting assembly 20 allows the armrest 16 to be mounted relative to the bench seat 10 without the use of tools. That is, the installer may insert the key 24 into the catch 22 by hand, and the armrest 16 will be restrained in the installed position as shown in FIG. 7.

The key 24 may be removed from the catch 22 by applying a force to the spring release surface 62 sufficient to flex the hook spring 46 outwardly as shown in FIG. 6. It should be appreciated that the spring release surface 62 may be shaped to facilitate an installer applying the sufficient force by hand. That is, the armrest 16 may be installed on the bench seat 10 without requiring the use of any sort of tool. Once the installer has applied sufficient force to move the spring release surface 62 to the release position, the pivot shaft 54 will no longer be restrained by the spring edge 50 and, therefore, may be pulled out of the guide channel 38. This allows the armrest 16 to be removed from the bench seat 10.

Although one embodiment of a mounting assembly 20 has been described in detail, it should be appreciated that alternatives to this embodiment are contemplated and may be used. For instance, instead of the guide edge 42 and the spring edge 50 restraining the pivot shaft 54 in the installed position shown in FIG. 7, the pivot shaft 54 could be restrained in the installed position by the sides of the spring space 50.

Referring back to FIG. 2, there is shown a misalignment indicator 70. The misalignment indicator 70 provides a visually perceptible indication when the mounting assembly 20 and the armrest 16 are not properly installed relative to the bench seat 10. The misalignment indicator 70 is a component having a different physical appearance from the surrounding portions of the armrest 16. The illustrated misalignment indicator 70 is a member having an arcuate shape with an inner radius of approximately 12 mm and an outer radius of approximately 24 mm. The misalignment indicator 70 has an angular extension of approximately 90 degrees. It should be appreciated that the misalignment indicator 70 may have a different appearance, such as a different color or texture, or be made of a different material. Further, the misalignment indicator 70 may have different dimensions, depending on the location and configuration of the mounting assembly 20 and the other components of the bench seat 10 and the armrest 16.

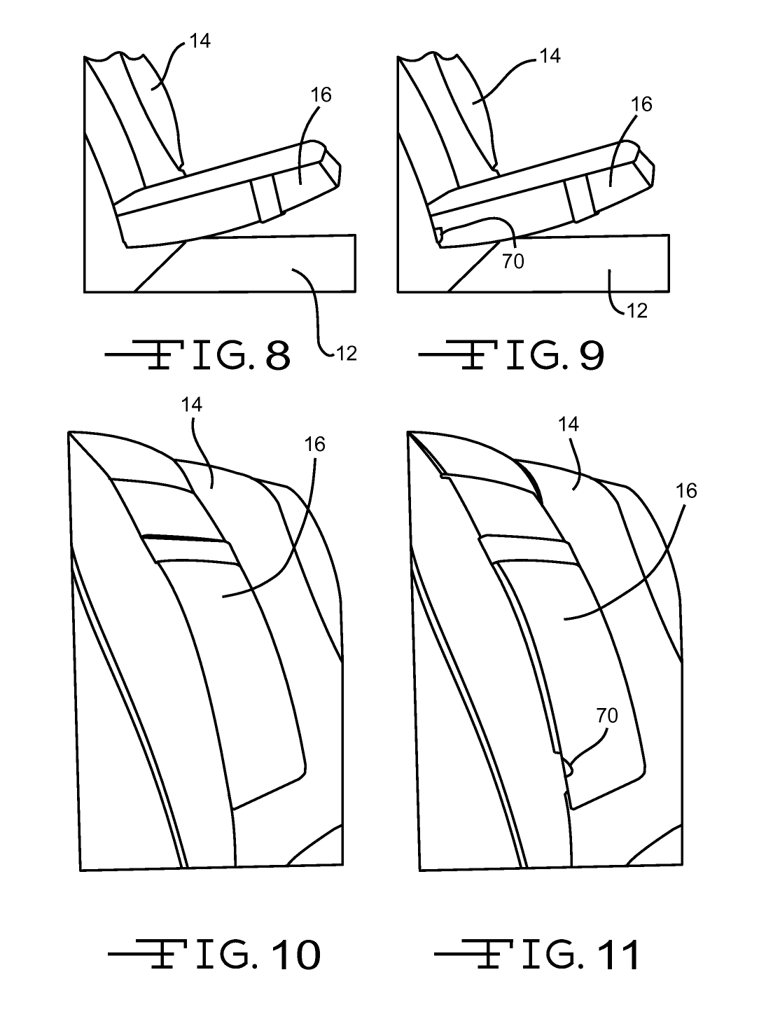

Referring to FIG. 8, the armrest 16 is shown properly installed relative to the bench seat 10 and in the use position. It is possible that the installer may not completely insert the pivot shaft 54 into the guide channel 38. In such a case, the pivot shaft 54 would be positioned somewhere to the right of the installed position, as viewed in FIG. 6. Frictional forces between the bench seat 10 and the armrest 16 may be sufficient to hold the armrest 16 in this position, thus making it appear that the mounting assembly 20 was properly assembled and that the armrest 16 was properly installed. However, as shown in FIG. 9, the misalignment indicator 70 may be visible. This provides a visual indication to the installer that the armrest 16 has not been properly installed. This also alerts the installer that some sort of corrective action should be taken in order to properly assemble the mounting assembly 20. Referring back to FIG. 8, when the armrest 16 is properly installed relative to the bench seat 10 the misalignment indicator 70 is not visible.

Referring to FIG. 10, the armrest 16 is shown properly installed and in the stowage position. Referring to FIG. 11, the armrest 16 is shown improperly installed and the misalignment indicator 70 is visible. The misalignment indicator 70 provides the visual indication of misalignment.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A mounting assembly for an armrest, the mounting assembly comprising:
a pivot shaft fixed relative to one of an armrest and a seat;
a brake shaft fixed relative to the pivot shaft;
a resilient restraining member, mounted relative to the other of an armrest and a seat, the resilient restraining member movable between a restrain position in which the resilient restraining member restrains the pivot shaft in an installed position, and a release position in which the resilient restraining member does not restrain the pivot shaft in the installed position;
a brake channel that engages the brake shaft when the pivot shaft is in the installed position;
wherein the armrest may be pivoted relative to the seat between a use position and a stowed position when the pivot shaft is in the installed position.

2. The mounting assembly of claim 1, wherein the resilient restraining member is biased toward the restraining position.

3. The mounting assembly of claim 2, wherein the resilient restraining member includes a release surface that is shaped so that the pivot shaft engages the release surface and applies a force to move the resilient restraining member from the restrain position to the release position when the armrest is moved from an uninstalled position toward the installed position.

4. The mounting assembly of claim 3, wherein the release surface is shaped so that the pivot shaft is unable to apply a force to move the resilient restraining member from the restrain position to the release position when the armrest is in the installed position.

5. The mounting assembly of claim 4, wherein the brake shaft extends a brake shaft length from a side of the armrest, the pivot shaft extends a pivot shaft length from the side of the armrest, and the pivot shaft length is greater than the brake shaft length.

6. The mounting assembly of claim 4, further comprising a guide channel positioned relative to the resilient restraining member so that the pivot shaft is moved through the guide channel when the armrest is moved from the uninstalled position to the installed position.

7. The mounting assembly of claim 6, wherein the brake shaft is moved through the guide channel when the armrest is moved from the uninstalled position toward the installed position.

8. The mounting assembly of claim 4, further comprising a misalignment indicator mounted relative to one of the armrest and the seat, wherein the misalignment indicator provides a visually perceptible indication when the armrest is not properly installed relative to the seat.

9. The mounting assembly of claim 4, further comprising a second pivot shaft fixed relative to one of an armrest and a seat, and a second resilient restraining member mounted relative to the other of an armrest and a seat, the second resilient restraining member movable between a restrain position in which the resilient restraining member restrains the second pivot shaft in an installed position, and a release position in which the second resilient restraining member does not restrain the second pivot shaft in the installed position.

10. A mounting assembly for an armrest, the mounting assembly comprising:
a key fixed relative to one of an armrest and a seat;
a catch mounted relative to the other of an armrest and a seat, the catch including a resilient restraining member movable between a restrain position in which the resilient restraining member restrains the key in an installed position, and a release position in which the resilient restraining member does not restrain the key in the installed position, wherein the armrest may be pivoted relative to the seat between a use position and a stowed position when the key is in the installed position; and
a misalignment indicator mounted relative to one of the armrest and the seat, wherein the misalignment indicator provides a visually perceptible indication when the armrest is not properly installed relative to the seat.

11. The mounting assembly of claim 10, wherein the catch includes a resilient restraining member that is movable between a restrain position in which the resilient restraining member restrains the key in an installed position, and a release position in which the resilient restraining member does not restrain the key in the installed position.

12. The mounting assembly of claim 11, wherein the resilient restraining member is biased toward the restraining position.

13. The mounting assembly of claim 12, wherein the resilient restraining member includes a release surface that is shaped so that the key engages the release surface and applies a force to move the resilient restraining member from the restrain position to the release position when the armrest is moved from an uninstalled position toward the installed position.

14. The mounting assembly of claim 13, wherein the release surface is shaped so that the key is unable to apply a force to move the resilient restraining member from the restrain position to the release position when the armrest is in the installed position.

15. The mounting assembly of claim 14, further comprising a guide channel positioned relative to the resilient restraining member so that the key is moved through the guide channel when the armrest is moved from the uninstalled position to the installed position.

16. A mounting assembly for movably supporting an armrest relative to a seat comprising:
a brake sleeve adapted to be supported on one of an armrest or a seat, the brake sleeve including an edge and having a brake channel proved thereon;
a restraining member supported on the brake sleeve, the restraining member including an edge;
a pivot shaft adapted to be supported on the other of the armrest or the seat, the pivot shaft engaging the edge of the brake sleeve and the edge of the retraining member so as to movably support the armrest relative to the seat; and
a brake shaft adapted to be supported on the other of the armrest or the seat, the brake shaft engaging the brake channel during movement of the armrest relative to the seat.
